(19) United States
(12) Patent Application Publication
(10) Pub. No.: US 2016/0192052 A1
(43) Pub. Date: Jun. 30, 2016

(54) AUDIO DEVICE

(71) Applicant: Bill Yang, Taipei City (TW)

(72) Inventor: Bill Yang, Taipei City (TW)

(73) Assignee: COTRON CORPORATION, Taipei City (TW)

(21) Appl. No.: 14/676,751

(22) Filed: Apr. 1, 2015

(30) Foreign Application Priority Data
Dec. 24, 2014 (TW) 103145224

(51) Int. Cl. H04R 1/10

(52) U.S. Cl. CPC H04R 1/1041

(57) ABSTRACT

An audio device including a signal cable and a control unit is provided. The control unit includes a case, a metal circuit and a microphone. The case has an appearance surface and an insulating inner surface. The metal circuit is disposed on the insulating inner surface, directly contacted with the insulating inner surface and electrically connected to the signal cable. The microphone is disposed on the insulating inner surface and bonded to the metal circuit.

### CROSS-REFERENCE TO RELATED APPLICATION

This application claims the priority benefit of Taiwan application serial no. 103145224, filed on Dec. 24, 2014. The entirety of the above-mentioned patent application is hereby incorporated by reference herein and made a part of this specification.

### BACKGROUND OF THE INVENTION

1. Field of the Invention

The invention relates to an audio device, and relates particularly to an audio device having a control unit.

2. Description of Related Art

Along with continuously improving industrial technology, electronic products are all developing towards a Lightweight and miniaturized trend. People may use miniaturized electronic products any time any where, such as an MP3 player, a smart phone, a tablet computer or a note book computer and the like to enjoy a variety of media entertainment. No matter what kind of electronic product mentioned above, earphones have already become an indispensable accessory for an electronic product in order for a user to listen to sound information that is provided by the electronic product without disturbing other people. In addition, an earphone may also provide a listener with better sound transmission such that the listener is able to hear clearly and understand the sound content unlike sound that is transmitted in air which may cause an unclear situation. In particular, a user will not be affected during a period when moving, for example, exercising, driving a car, in intense activity or in a noisy environment.

FIG. 1 is a cross-section view of a control unit of a conventional earphone. Referring to FIG. 1, in a control unit 100 of a conventional earphone, a key 120 is disposed on a surface of a circuit board 110, and a microphone 130 is disposed on the other surface of the circuit board 110. With the control unit 100 being made smaller, all that is needed is an error to occur in the dimensions of one component or an error to appear during the assembly, to have a substantial influence in regards to the performance of a component. In terms of the microphone 130, an error occurring in the dimensions of the circuit board 110, the microphone 130 or a case 140 will cause a leak to occur in a chamber 142 which is between the microphone 130 and the case 140, such that the sound received by the microphone 130 sounds muffled. In addition, due to limitations in space, a distance between the key 120 and the case 140 needs to be accurately controlled, otherwise a problem where the key 120 is continuously pressed by the case 140 and unable to be released occurs. In particular, under a circumstance when there are a numerous amount of components and the assembly process is complicated, it is not easy to increase the product yield rate, and even the thickness of the circuit board 110 may be a key factor that will influence the yield rate.

### SUMMARY OF THE INVENTION

The invention provides an audio device that may improve a problem where the precision of the dimensions and assembly affects the product yield rate.

An audio device of the invention includes a signal cable and a control unit. The control unit includes a case, a metal circuit and a microphone. The case has an appearance surface and an insulating inner surface. The metal circuit is disposed on the insulating inner surface and directly contacted with the insulating inner surface and electrically connected to the signal cable. The microphone is disposed on the insulating inner surface and bonded to the metal circuit.

In an embodiment of the invention the control unit further includes a key disposed on the insulating inner surface and bonded to the metal circuit.

In an embodiment of the invention, the control unit further includes a protective adhesive deposited between a periphery of the key and the insulating inner surface.

In an embodiment of the invention, the case includes a fixing part and a moving part. The metal circuit is located at the fixing part, the moving part is movably assembled to the fixing part and used to press the key.

In an embodiment of the invention, the case further has two line input ports. Inside each of the line input ports 316 there is a blocking structure, a part of the signal cable passing through the line input port is S shaped.

In an embodiment of the invention, the case further has a sound receiving hole, the location thereof is corresponding to the microphone.

In an embodiment of the invention, the case further has an isolation wall encircling the sound receiving hole and the microphone.

In an embodiment of the invention, the metal circuit is formed on the insulating inner surface by electroplating.

In an embodiment of the invention, the case is constructed from a homogeneous material.

In an embodiment of the invention, the signal cable and the metal circuit on the insulating inner surface is adhesively bonded by the conductive adhesive.

In an embodiment of the invention the audio device further includes at least one earphone unit that is electrically connected to the signal cable.

Based on the above, the audio device of the invention omits a circuit board inside a control unit. Therefore, the factors affecting the accuracy of the dimensions and assembly are decreased and it is easy to achieve a better product yield rate.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-section view of a control unit of a conventional earphone.

FIG. 2A is a schematic diagram of an audio device according to an embodiment of the invention.

FIG. 2B is a schematic diagram of an audio device according to another embodiment of the invention.

FIG. 3 is a cross-section view of a control unit of the audio device of FIG. 2A.

FIG. 4 illustrates an effect that the distance between a microphone and a case has on the sensitivity of the microphone.

FIG. 5. is a cross-section view of a control unit of an audio device according to another embodiment of the invention.

FIG. 6 illustrates the effect that whether there is a leak between a microphone and a case has on the sensitivity of the microphone.

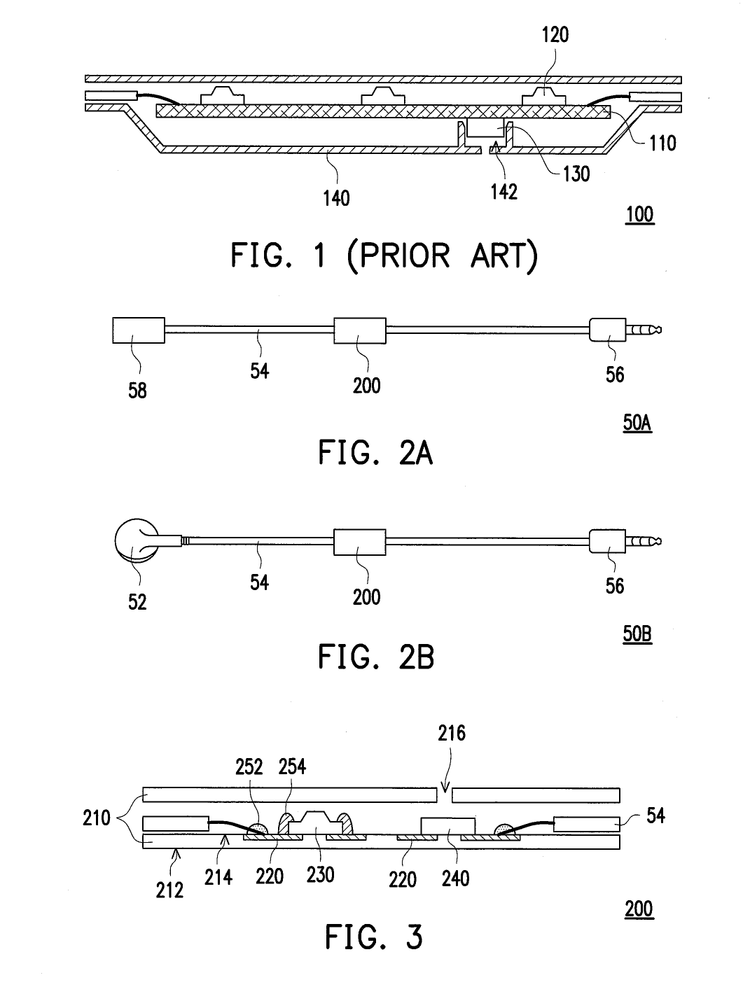

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2A is a schematic diagram of an audio device according to an embodiment of the invention. Referring to FIG. 2A, an audio device 50A of an embodiment of the invention includes a signal cable 54 and a control unit 200. The audio device 50A of the present embodiment may further include a male connector 56 and a female connector 58. The signal cable 54 connects the female connector 58, the control unit 200 and the male connector 56 together in sequence. The male connector 56 is used to connect to an audio player (not illustrated), for example, a smart phone, a tablet computer or some other audio player. The signal cable 54 transmits an audio signal provided by the audio player to the female connector 58 in order for an earphone, a speaker or other receiving device (not illustrated) that is connected to the female connector 58 to use the audio signal. The signal cable 54 also transmits a control signal that is sent by the control unit 200 to the audio player. The signal cable 54 of the present embodiment is exposed on the outside of the control unit 200, as an example. However, the male connector 56 may also be connected directly to the control unit 200 but the male connector 56 still is actually electrically connected to the control unit 200 by the signal cable 54 that is hidden inside the control unit 200. In addition, the female connector 58 may be directly integrated in the control unit 200, but the female connector 58 still is actually electrically connected to the control unit 200 by the signal cable 54 that is hidden inside the control unit 200.

FIG. 2B is a schematic diagram of an audio device according to another embodiment of the invention. Referring to FIG. 2B, an audio device 50B of the present embodiment and the audio device 50A of FIG. 2A are similar. The difference is the audio device 50B of the present embodiment includes at least one earphone unit 52. The signal cable 54 connects the earphone unit 52, the control unit 200 and the male connector 56 together in sequence. The signal cable 54 transmits the audio signal provided by the audio player to the earphone unit 52, to drive the earphone unit 52 to convert the audio signal to sound. In addition, the present embodiment uses a single earphone unit 52 as an example, but other embodiment may include two earphone units to provide the user with a stereophonic sensation.

Referring to FIG. 3, the control unit 200 includes a case 210, a metal circuit 220, at least one key 230 and one microphone 240. The case 210 has an appearance surface 212 and an insulating inner surface 214. The metal circuit 220 is disposed on the insulating inner surface 214 and directly contacts the insulating inner surface 214, and is electrically connected to the signal cable 54. The key 230 is disposed on the insulating inner surface 214 and bonded to the metal circuit 220. The microphone 240 is disposed on the insulating inner surface 214 and bonded to the metal circuit 220. More specifically, the appearance surface 212 of the case 210 is the surface which a user sees when using the control unit 200, and the insulating inner surface 214 of the case 210 is the inner surface which the user can not see when using the control unit 200. Furthermore, the present embodiment uses a control unit 200 that includes the key 230 as an example, but in other embodiments the control unit 200 may only provide the microphone 240 that is used to receive sound and not include the key 230.

The difference compared to conventional techniques where a circuit board is fixed in the case after the circuit is formed on the circuit board, is that in the present embodiment the metal circuit 220 is formed directly on the insulating inner surface 214 of the case 210, omitting the use of a circuit board. In this way, the distance between the top of the microphone 240 and the case 210 above the microphone 240 may be easily controlled within design dimensions because the distance is only be affected by the dimensional error of the case 210, the dimensional error of the microphone 240 and the assembly error when the microphone 240 is fixed to the insulating inner surface 214. In this way, it may be easily assured that the microphone 240 achieves the best sound receiving effect. In addition, the distance between the top of the key 230 and the case 210 that is above the microphone 240 may be easily controlled within design dimensions, and the possibility that the key 230 is continuously pressed by the case 210 and unable to be released is lowered, further increasing the product yield rate.

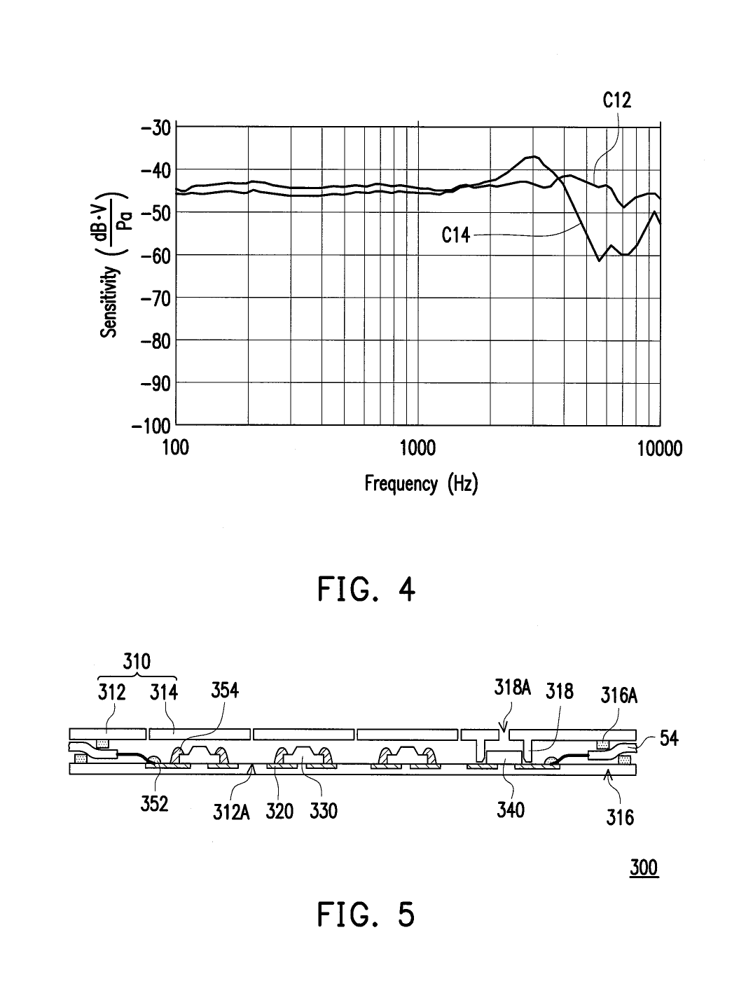

FIG. 4 illustrates an effect that the distance between a microphone and a case has on the sensitivity of the microphone. Referring to FIG. 4, a curve C12 represents a condition where the distance between the top of the microphone and the case above the microphone is maintained at an ideal design value, and it may be seen here that the sensitivity of the microphone with respect to various frequencies is approximately the same. A curve C14 represents the condition where the distance between the top of the microphone and the case above the microphone is greater than an ideal design value, and it may be seen here that the sensitivity of the microphone with respect to some frequencies is not ideal. Therefore, adopting the control unit 200 of the FIG. 3 may assure the microphone 240 has a better sensitivity and may record a sound signal with lower distortion.

The case 210 of the present embodiment further has a sound receiving hole 216. The position of the sound receiving hole 216 corresponds with the microphone 240. The metal circuit 220 of the present embodiment is embedded in the insulating inner surface 214 of the case 210. However, the metal circuits of other embodiments may not be embedded in the insulating inner surface 214 of the case 210. In addition, the case 210 of the present embodiment is constructed from homogeneous material, namely the material of the overall case 210 is uniform, and not formed by stacked layers of a plurality of materials such as a typical circuit board. For example, when forming the metal circuit 220, the case 210 having a special material on the insulating inner surface 214 may be adopted, and the portion of the material that has been activated may attract metal ions to be deposited thereon during electroplating and the portion that has not been activated will not have metal ions deposited thereon during electroplating. Therefore, a metal circuit 220 with a pattern desired by a designer may be formed on the insulating inner surface 214. In addition, the control unit 200 also may selectively include a conductive adhesive 252 and a protective adhesive 254. The conductive adhesive 252 is used to adhesively bond the signal cable 54 and the metal circuit 220 on the insulating inner surface 214. The conductive adhesive 252 may be selectively used to prevent a problem where conventional high temperature soldering may damage the case 210. The protective adhesive 254 is deposited between the periphery of the key 230 and the insulating inner surface 214, to strengthen the adhesive strength between the key 230 and the insulating inner surface 214 to further increase the overall reliability. Of course, the protective adhesive 254 may be used between the microphone 240 and the insulating inner surface 214 to strengthen the adhesive strength.

FIG. 5. is a cross-section view of a control unit of an audio device according to another embodiment of the invention. A control unit 300 of the audio device in the present embodiment and the control unit 200 of FIG. 3 are similar, and only the differences will be introduced here. A case 310 of the control unit 300 includes a fixing part 312 and a moving part 314. The metal circuit 320 is located on the insulating inner surface 312A of the fixing part 312 and the moving part 314 is movably assembled to the fixing part 312 and is used to press a key 330. Due to the metal circuit 320 being located on the insulating inner surface 312A of the fixing part 312, an increase in the overall dimensional error caused by using a circuit board may be avoided, further increasing the product yield rate. In addition, the moving part 314 is movably assembled to the fixing part 312 such that it may move slightly relative to the fixing part 312, and does not mean that the moving part 314 and the fixing part 312 are fixed such that they cannot move relative to each other. In principle, the movable distance should be sufficient enough for the key 330 to be pressed. The number of keys 330 in the present embodiment is three and are fixed on the insulating inner surface 312A by the protective adhesive 354. However, it should not be construed as a limitation to the invention and number wise there may be more or less. The moving part 314 of the present embodiment may be divided into three individually movable parts according to the number of the keys 330. Of course, even if the moving part 314 is not disposed on the case 310, the amount of elastic deformation of the case 310 itself may be used to achieve an objective of pressing the keys 330.

The case 310 of the present embodiment further has two line input ports 316. Inside each line input ports 316 there is a blocking structure 316A and the part of the signal cable 54 passing through the line input port 316 is S shaped. By disposing the blocking structure 316A, a suitable fixing force may be provided to the signal cable 54 when the signal cable 54 is pulled and prevents the connecting relationship between the signal cable 54 and the metal circuit 320 from being damaged. In addition, the signal cable 54 and the metal circuit 320 on the insulating inner surface 312A may be adhesively bonded by the conductive adhesive 352. There are a plurality of configurations for the blocking structure 316A, and the configuration disclosed here is only an example. The signal cable 54 is S shaped refers to a bend in the signal cable 54 that will be produced due to the blocking structure 316A, however it is not to restrict the signal cable 54 to be the same as the shape of the letter S. In addition, the case 310 of the present embodiment further has an isolation wall 318, encircling a sound receiving hole 318A and a microphone 340. The isolation wall 318 assists in assuring the sound receiving effect of the microphone 340. In addition, the dimensional error produced is decreased by the omission of the use of a circuit board and the chamber above the microphone does not leak easily.

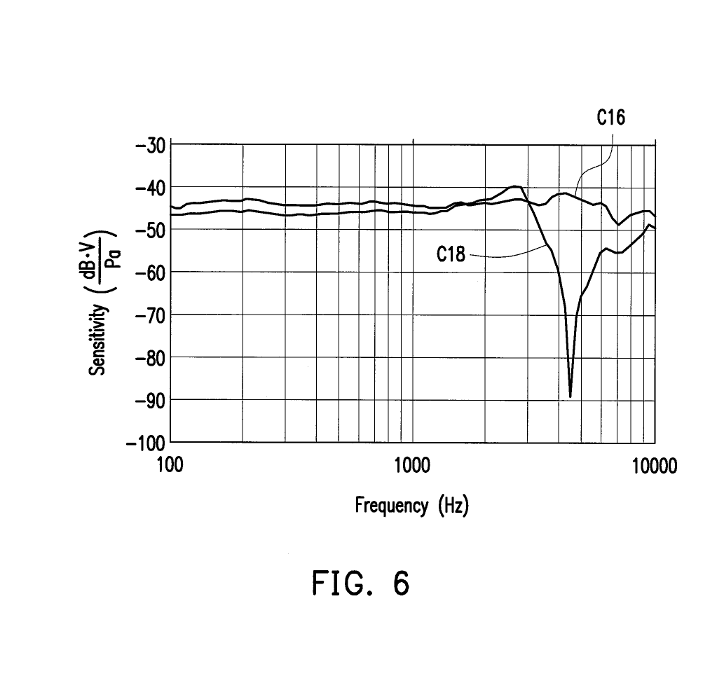

FIG. 6 illustrates the effect that whether there is a leak between a microphone and a case has on the sensitivity of the microphone. Referring to FIG. 6, a curve C16 represents a condition when the chamber above the microphone is not leaking, and it may be seen here that the sensitivity of the microphone with respect to various frequencies is approximately the same. A curve C18 represents a condition when the chamber above the microphone is leaking, and it may be seen here that the sensitivity of the microphone with respect to some frequencies is not ideal. Therefore, adopting the control unit 300 as shown in FIG. 5 may assure that the microphone 340 has a better sensitivity and may record a sound signal with lower distortion.

In summary, an audio device of the invention forms a metal circuit in the control unit and directly on the inner surface of the case, and the circuit board which is used to carry the circuit in conventional techniques is omitted. Therefore, the possibilities of where the final dimension may be affected by the dimensional error of the circuit board, the assembly error of the electronic components and the circuit board, and the assembly error of the circuit board and the case are decreased. In this way, it is easier to obtain a better sound receiving effect for a microphone and when setting the keys there is a better operational feel.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An audio device, comprising:
a signal cable; and
a control unit, comprising:
a case, having an appearance surface and an insulating inner surface;
a metal circuit, disposed on the insulating inner surface and directly contacted with the insulating inner surface and electrically connected to the signal cable;
a microphone, disposed on the insulating inner surface and bonded to the metal circuit.

2. The audio device as claimed in claim 1, wherein the control unit further comprise a key, disposed on the insulating inner surface and bonded to the metal circuit.

3. The audio device as claimed in claim 2, wherein the control unit further comprise a protective adhesive deposited between a periphery of the key and the insulating inner surface.

4. The audio device as claimed in claim 2, wherein the case comprise a fixing part and a moving part, the metal circuit is located at the fixing part, the moving part is movably assembled to the fixing part and used to press the key.

5. The audio device as claimed in claim 1, wherein the case further has two line input ports, and inside each of the line input ports there is a blocking structure, a part of the signal cable passing through the line input port is S shaped.

6. The audio device as claimed in claim 1, wherein the case further has a sound receiving hole and the location thereof corresponds to the microphone.

7. The audio device as claimed in claim 6, wherein the case further has an isolation wall encircling the sound receiving hole and the microphone.

8. The audio device as claimed in claim 1, wherein the metal circuit is formed on the insulating inner surface by electroplating.

9. The audio device as claimed in claim 1, wherein the case is constructed from a homogeneous material.

10. The audio device as claimed in claim 1, wherein the signal cable and the metal circuit on the insulating inner surface is adhesively bonded by a conductive adhesive.

11. The audio device as claimed in claim 1, further comprising at least one earphone unit that is electrically connected to the signal cable.
